(19) United States
(12) Patent Application Publication
(10) Pub. No.: US 2002/0112096 A1
(43) Pub. Date: Aug. 15, 2002

(54) Methods and apparatus for exchanging coded information

(76) Inventors: David Louis Kaminsky, Chapel Hill, NC (US); David Johnson, Apex, NC (US); David Ogle, Cary, NC (US); Thomas Rowe, Chapel Hill, NC (US); Gregory DeKoenigsberg, Durham, NC (US); Daniel Paul Gajewski, Chapel Hill, NC (US)

Correspondence Address: Capstone Law Group LLP, 250A Twin Dolphin Drive, Redwood City, CA, 94065, US

(21) Appl. No.: 10/043,574

(22) Filed: Jan. 9, 2002

Related U.S. Application Data
(60) Provisional application No. 60/260,583, filed on Jan. 9, 2001.
(60) Provisional application No. 60/156,020, filed on Sep. 23, 1999.
(60) Provisional application No. 60/180,466, filed on Feb. 4, 2000.

(51) Int. Cl. G06F 9/46

(52) U.S. Cl. 709/330

(57) ABSTRACT

Information/web page content is provided to a client and tailored to specific users by including user or session-specific identity data in the initial query. The identity data are obtained from reading a code from a physical object, combining the code with information stored within the client, and embedding the result in the initial query. Before transmitting the query, the data can be compressed using a technique that resists inadvertent expansion caused by URL encoding. A server receiving the query operates on the identity data using, for example, a scoring algorithm and maps the query to a target URL specifying the location of the tailored information. If the file associated with the target URL cannot be located, the server accesses an error handling system to provide the user with alternative content. The server logs the query, including the associated target URL, providing a data warehouse capability.

### CROSS REFERENCE TO RELATED APPLICATIONS

This application is related to the following co-pending U.S. patent applications, assigned to the assignee of the present invention, and are incorporated herein by reference in the entirety for all purposes:

Ser. No. 60/156,020; filed Sep. 23, 1999,

Ser. No. 09/440,318; filed Nov. 12, 1999,

Ser. No. 60/180,466; filed Feb. 4, 2000, and

Ser. No. 09/567,936; filed May. 10, 2000.

### FIELD OF THE INVENTION

The present invention relates generally to communications between servers and clients and, more specifically, to techniques allowing end users to request and receive coded information tailored to the specific needs of a client-server environment.

### BACKGROUND OF THE INVENTION

The rapid growth and availability of networked computer systems has provided the impetus in developing interactive user interfaces for end users. An example of an interactive computer network is the World Wide Web (hereafter, the “web”). The web includes web pages transmitted over the Internet and accessed by end users using a software application known as a web browser or, simply, a “browser.” Example browsers include Internet Explorer by Microsoft Corporation of Redmond, Wash., and Netscape Navigator by Netscape Communications Corporation of Mountain View, Calif. The browser allows users to interact with the content of the web pages through a graphical user interface. These web pages represent information using hypertext links and other user interface constructs available through many different markup languages including hypertext markup language (HTML). The browser can display web pages with content ranging from simple text materials to elaborate multimedia presentations.

Computers on the web are generally organized as a client-server based computer network. Server computers connected to the Internet store a vast amount of information accessed through the web and viewed through browsers. Web pages are an example of the information that typically resides on these servers that an end user accesses. The browser is a “client” that transmits a request over the Internet to a server at an address and then accesses the information available on a specific web page identified by the address. This specific address is known as the Uniform Resource Locator (“URL”). In response to the end user's request, the server housing the specific web page will transmit (i.e., “download”) a copy of that web page over the Internet to the end user's web browser for display.

To ensure proper routing of messages between the server and the intended client, the messages are first broken up into data packets. Each data packet receives a destination address according to a protocol. The data packets are reassembled upon receipt by the target computer. Commonly accepted sets of protocols used for this purpose are the Internet Protocol (hereafter, “IP”) and Transmission Control Protocol (hereafter, “TCP”). The IP layer generally determines routing information for the data packets while the TCP layer determines how to separate the messages into IP packets for transmission, subsequent collection and later reassembly. TCP/IP connections are typically employed to move data across the Internet regardless of the medium actually used in transmitting the signals.

Any Internet “node” can access a specific web page by invoking the proper communication protocol and specifying the URL. (A “node” is a computer with an IP address whether the address is assigned permanently to a server connected to the Internet or a client that has dynamically established a connection to a server and received a temporary IP address. Typically, the URL has the format http://<host>/<path>, where “http” refers to the HyperText Transfer Protocol, “host” is the server's Internet identifier, and the “path” specifies the location of a specific web page file typically stored as a file within the server.

As computing technology has evolved, users have increased their access to a large amounts of information from an increasing universe of data sources. Information from these sources is available to any user with a network connection to the Internet and a suitable browser capable of “browsing.” Despite advances in hardware and software, the sheer volume of information available can overwhelm an end user. An end user's attempts to access information relevant to his needs may fail because much of the material located by browsing may be generic or otherwise have little or no actual value to the end user.

Compounding this problem is the difficulty end users can have when attempting to recall the URLs of web pages of interest. Typically, an end user specifies a URL by typing its characters on the keyboard of the client device, thereby eliciting a response from a browser. Nevertheless, many URLs have become longer (i.e., use more characters) and counterintuitive. These attributes combine to increase the difficulty an end user can experience when attempting to access information of interest.

From the foregoing, it is apparent that there is still a need for a way that allows an end user to quickly and efficiently cull information of interest from the vast amounts of data available on a computer network, such as the Internet. Such a method should also promote the delivery of information that is tailored to the end user's needs or environment, or both.

### SUMMARY OF THE INVENTION

Advantages that can be seen in implementations of the invention include one or more of the following. The present invention provides a way for end users to locate relevant information from the volume of data available on a computer network, such as the Internet. The information can be tailored to one or more of the end user's interests, needs, or environment, thereby reducing the potential of delivering generic, and potentially irrelevant, data. The invention simplifies the end user's interaction with the network by eliminating the need for manual entry of long or complicated URLs.

One embodiment of the invention features a method of providing information from a server to a client. As a first step, the client accepts a request for information from the end user. The client then constructs an identifier, such as a URL, that specifies the source of the information. The information can be resident on the server (i.e., making the server the “source” of the information). Typically, though, the information resides on a web site or another network node. The identifier also includes a differentiating indicator that incorporates, for example, data identifying one or more of a device type, an end user, a user group, and a location. The client then transmits the identifier with the included (e.g. embedded) differentiating indicator to the server.

After receipt of the identifier, the server locates the information requested by the end user. The server then tailors (e.g., personalizes) the information for the end user based on the differentiating indicator and then transmits this tailored information to the client. The tailoring is performed by, for example, computing a score according to a predefined algorithm that operates on the differentiating indicator. This computation occurs at either the client location or the server location, and the value of the score determines, at least in part, the nature of the tailoring, for example, which information is selected for transmission to the client. This selection occurs at either the client location or the server location.

In a related embodiment, the invention provides an article of manufacture that includes a program storage medium having computer readable program code for causing a server to provide information to a client. The computer readable program code causes a computer to accept the request for information, construct the identifier with the included (e.g., embedded) differentiating indicator and transmit it to the server, tailor the information based on the differentiating indicator, and transmit the information from the server to the client. In a different embodiment, a program storage medium tangibly embodies a program of instructions executable by the computer to perform the corresponding method steps for the aforementioned delivery of tailored information to an end user.

In another embodiment, the initial request for information includes the step of interpreting a code associated with an article of commerce. The code is, for instance, a code, such as a digital watermark, placed on the article as a form of identification. By way of example, the interpretation includes scanning the code using optical, radio frequency, magnetic or other methods. This code is then included in the identifier. To increase the accuracy of the interpretation, a data stream generated by the interpretation action (e.g., scanning) is examined to determine its rate and the presence of at least one preamble character that is typically included with the code. By assessing the data stream rate, or the presence of at least one preamble character, or both, the accuracy of the identifier may be improved, thereby improving the accuracy of the initial request for information.

In a further embodiment, the code associated with an article of commerce is compared with one or more known code types (e.g., code formats). This is accomplished by, for example, comparing the number of characters in the code with the number of characters in the known code type. Alternatively, the code checksum is compared with the checksum of the known code type. Irrespective of the method used, the differentiating indicator is then defined to be the code type that matches the code associated with an article of commerce.

In another embodiment, the server, after receipt of the identifier, maps the identifier to a “target URL”. Because the identifier can be unique, the result of the server mapping the identifier can be a unique target URL. This URL is thus tailored to the particular end user. In other words, the server is still providing tailored information to the end user by providing the client with a “tailored pointer” (the unique target URL) to information. This method is as if the server itself was tailoring the information, and both methods are within the scope of the present invention. The server then transmits this target URL to the client. The client, typically using a browser, then accesses the target URL and displays the associated target file (e.g., the corresponding web page) to the end user. When the associated target file does not exist, the server accesses an error handling system. This error handling system intercepts an error generated by the server due to the missing target file. The system, for example, provides a new target URL to the client that corresponds to a default content address. As an alternative, the system executes a root error handler program, the output of which specifies a new target URL that is also provided to the client. In any event, an objective of the error handling system is to redirect the end user to a new web page when the originally requested web page cannot be located. This redirection is typically seamless and generally performed without additional end user effort.

In a further embodiment, the target URL corresponds to an online form and the target URL also includes end user identification data that has been obtained from the differentiating indicator. The online form is responsive to the end user identification data. This allows, for example, the form to use the identification data to complete (i.e., “populate”) fields in the form corresponding to the data without end user effort. To illustrate, an online form that includes a field for the user name extracts that user name from the end user identification data included in the target URL. The end user then sees the form with the user name already inserted. The end user is thus freed from manually entering his name.

In another embodiment, the client collects behavioral data based on the end user's activity and includes this data in the differentiating indicator. These data incorporate, for example, the frequency at which a specific code associated with an article of commerce is used in an end user's requests for information. Various codes associated with an article of commerce can also be categorized. Consequently, the frequency at which a specific code category is used in an end user's requests for information can be included in the behavioral data.

In a further embodiment, information is provided from the server to the client by the client first accepting a request for information from an end user by interpreting a code associated with an article of commerce. The client then constructs an encrypted identifier that specifies a source of the information. The encrypted identifier includes the code associated with an article of commerce (e.g., the latter is embedded in the former). In its construction of the encrypted identifier, the client can perform the encryption or can use already encrypted data (e.g., incorporate an already encrypted code). The client then transmits this encrypted identifier to the to the server. The encrypted identifier is then mapped to a target URL without decryption. The server then transmits the target URL to the client.

In a related embodiment, the invention provides an article of manufacture that includes a program storage medium having computer readable program code for causing a server to provide information to a client. The computer readable program code causes a computer to accept the request for information by interpreting the code associated with an article of commerce, construct and transmit to the server the encrypted identifier with the included (e.g., embedded) code associated with an article of commerce, map the encrypted identifier to the target URL, and transmit the latter to the client. In a different embodiment, a program storage medium tangibly embodies a program of instructions executable by the computer to perform the corresponding method steps for the aforementioned delivery of information from a server to a client using the encrypted identifier.

In another related embodiment, the computer readable program code causes a computer to accept the request for information, construct the identifier and transmit it to the server, locate the information based on the identifier and transmit the information to the client if the information is found, or access the error handling system if the information is not found. A different embodiment includes a program storage medium that tangibly embodies a program of instructions executable by the computer to perform the corresponding method steps for the aforementioned actions.

In yet another embodiment, requests for information from a server to a client are logged. The client first accepts a request for information from an end user by interpreting a code associated with an article of commerce. The client then constructs an identifier that specifies a source of the information requested and includes the code. The client transmits this identifier to the server, which maps the identifier to a target URL. The server then transmits this target URL to the client.

In addition to transmitting the target URL, the server typically responds with a header that includes data regarding the exchange with the client. In this embodiment, at least one portion of this header response is logged (e.g., stored) for further analysis. By way of example, the target URL is caused to appear in the server header response, and the logged portion of the response includes the target URL.

In a related embodiment, the invention provides an article of manufacture that includes a program storage medium having computer readable program code for causing a computer to log requests for information from a server to a client. The computer readable program code causes a computer to accept the request for information by interpreting the code associated with an article of commerce, construct and transmit to the server the identifier with the included (e.g., embedded) code associated with an article of commerce, map the encrypted identifier to the target URL, log at least one portion of the server header response, and transmit the target URL to the client. In a different embodiment, a program storage medium tangibly embodies a program of instructions executable by the computer to perform the corresponding method steps for the aforementioned logging of requests for information from a server to a client.

In another embodiment, the invention offers a way to select the service level provided by a server to a client. The server can provide, for example, a service level that includes static content, such as simple web page displays. Alternatively, the server can provide dynamic content, such as web pages supporting interactive electronic commerce. In any event, the needs of the client and the nature of the information the end user requests influence the type of service level the server provides.

In this embodiment, a request for information is accepted and the client then selects a content type. An identifier, such as a URL, that specifies a source of the information is then constructed. Within this identifier is a designator that specifies the content type. This designator, which the client can determine, can also be determined at least in part from a code associated with an article of commerce. The identifier with the included (e.g., embedded) designator is then transmitted to the server and, after receipt, the server executes program instructions based on that designator. These program instructions cause the server to provide the selected content type (e.g., static or dynamic). The requested information is then transmitted from the server to the client using the selected content type.

In a related embodiment, the invention provides an article of manufacture that includes a program storage medium having computer readable program code for causing a computer to select the service level. The computer readable program code causes a computer to accept the request for information, select the content type, construct the identifier and include the designator within it, transmit it to the server, and execute program instructions based on the designator to select the service level. In a different embodiment, a program storage medium tangibly embodies a program of instructions executable by the computer to perform the corresponding method steps for the aforementioned selection of a service level.

A further embodiment features a way to include supplementary data in a request for information from a server. Initially, an identifier, such as a URL, that specifies a source of the information is constructed. The supplementary data are then compressed using a persistent compression. The compression is “persistent” because it resists decompression (or “expanding”) by mechanisms such as URL encoding. The supplementary data, once compressed, are included in the identifier, which is then transmitted to the server.

In a related embodiment, the invention provides an article of manufacture that includes a program storage medium having computer readable program code for causing a computer to include the supplementary data in the request for information. The computer readable program code causes a computer to construct the identifier, compress the supplementary data using a persistent compression technique and include it in the identifier, and transmit the identifier to the server. In a different embodiment, a program storage medium tangibly embodies a program of instructions executable by the computer to perform the corresponding method steps for the aforementioned inclusion of supplementary data in the request for information.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram illustrating a representative client-server implementation of the invention including a server and a client communicating over a network;

FIG. 2 is a block diagram illustrating components in a server for use with the present invention;

FIG. 3 is a block diagram depicting components found in a client and configured in accordance with the present invention;

FIG. 4 depicts pseudo-code associated with one embodiment of the invention useful when developing software;

FIG. 5 provides a flowchart diagram of the overall operations associated with exchanging coded information between a client and server in one embodiment;

FIG. 6 is a block diagram of operations performed on local servers, client and other servers;

FIG. 7 provides a flowchart diagram of the operations used to determine if an input stream is a scanned code or regular input;

FIG. 8 is a flow chart diagram providing the operations associated with generating an identifier having differentiating indicators;

FIG. 9 is a flow chart diagram providing the operations associated with distinguishing between the various types of codes associated with an article of commerce;

FIG. 10 is a flowchart diagram providing the operations associated with using behavioral data to tailor the response to a request for information;

FIG. 11 is a flowchart diagram providing the operations associated with using demographic information to tailor requested information;

FIG. 12 is a flow chart diagram providing the operations for performing persistent compression;

FIG. 13 is a flowchart diagram providing the operations used to map a request for information to a URL;

FIG. 14 is a flowchart diagram providing the operations used for entering logs and datamining the information in the logs; and

FIG. 15 is a flowchart diagram providing the operations associated with selecting the service level provided by a server to a client.

### DETAILED DESCRIPTION

As shown in the drawings for the purposes of illustration, the invention may be embodied in a method of quickly and efficiently delivering information to an end user tailored to the end user's specific needs, interests, and environment. A system according to the invention enriches the end user's browsing experience by providing desired information while reducing the likelihood of supplying irrelevant information. The invention avoids the problem of requiring the end user to enter long or complicated URLs to locate information of interest.

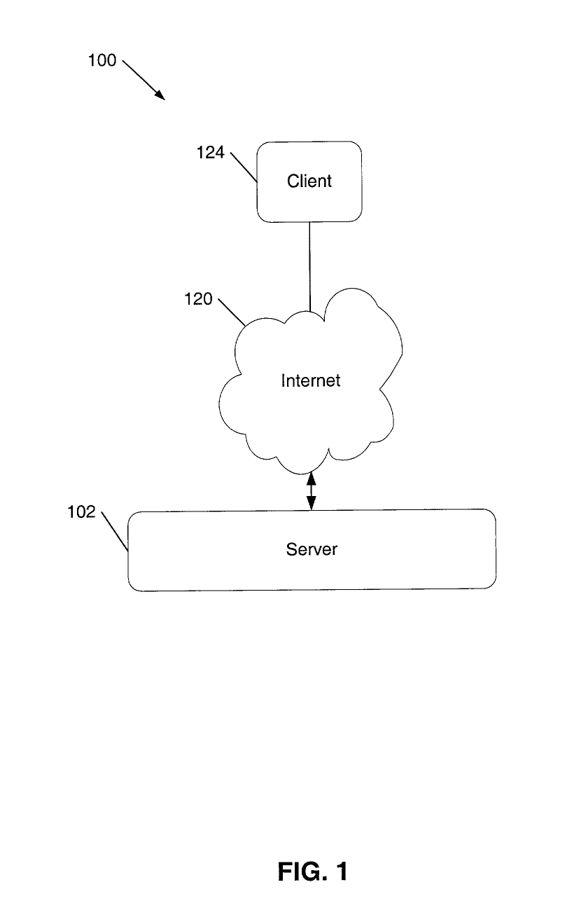

FIG. 1 shows a representative client-server implementation of the invention 100 that includes a server 102 and a client 124, which communicate over a medium such as the Internet 120. Typically, server 102 and client 124 communicate using TCP/IP or other packet-based communication technologies for data and/or voice carried over wired Plain Old Telephone System or Service (POTS) and wireless air interface technologies like Code Division Multiple Access (CDMA), Time Division Multiple Access (TDMA), Global System for Mobile Communications (GSM) and other spread spectrum, code-based or frequency hopping variations derived from or related to these wireless air interface technologies. It is also possible for TCP/IP and other protocols to be carried over legacy wireless analog technologies including Advanced Mobile Phone Service (AMPS) and Frequency Division Multiple Access (FDMA).

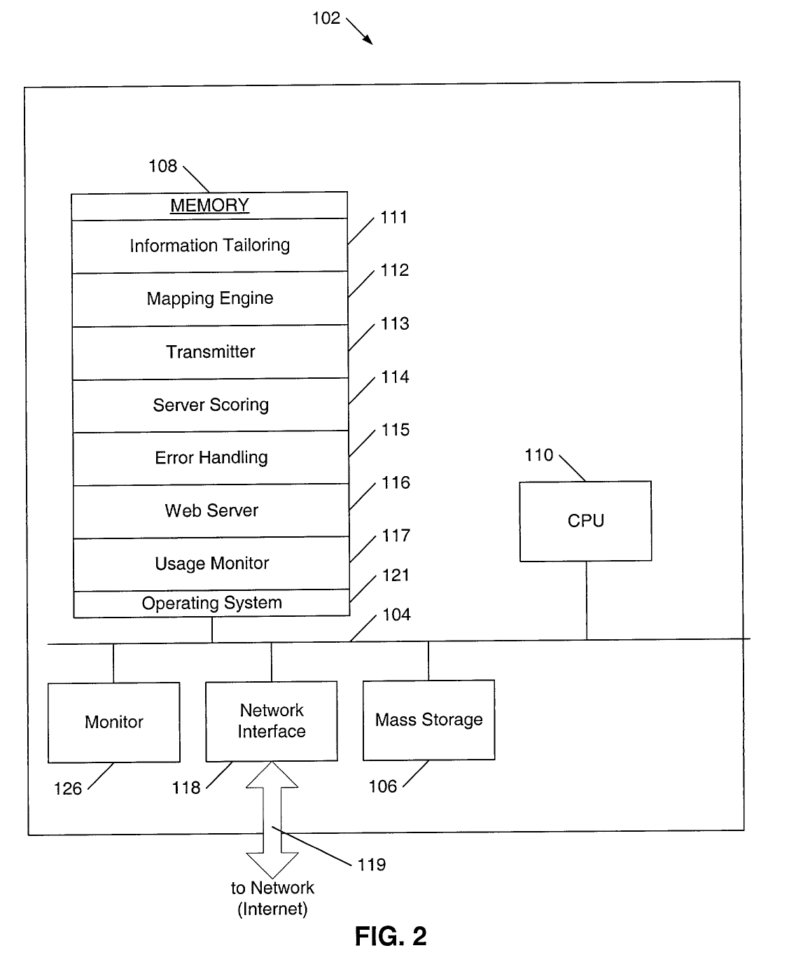

FIG. 2 is a block diagram illustrating components in server 102 for use with the present invention. In one embodiment, the components of server 102 intercommunicate over a main bi-directional system bus 104. The main sequence of instructions effectuating the invention reside on a mass storage device (such as a hard disk or optical storage unit) 106 as well as in a main system memory 108 during operation. Execution of these instructions and effectuation of some of the functions of the invention is accomplished by a central processing unit (“CPU”) 110. Within the server 102, a network interface 118 is connected to the main bi-directional system bus 104. The server 102 is connected to the Internet 120 via the network interface 118 and a server connection 119.

The executable instructions that control the operation of the CPU 110 and thereby effectuate the functions of the invention are conceptually depicted as a series of interacting modules resident within the memory 108 and includes operating system 121 that directs the execution of low-level, basic system functions such as memory allocation, file management and operation of the mass storage devices 106. Memory 108 includes an information tailoring module 111, a mapping engine 112, a transmitter module 113, a server scoring module 113, a error handling module 115, a web server module 116 and a usage monitor 117.

Web server software module 116 configures the server 102 as a web site, thereby conferring the capability of communicating over the web. Thus, web pages stored on the server 102 are made accessible across the web. Communication over the Internet 120 is accomplished by encoding information to be transferred into data packets. Each packet receives a destination address according to a consistent protocol, and each is reassembled upon receipt by the target computer. A commonly accepted set of protocols for this purpose includes the aforementioned Internet Protocol (“IP”) and the Transmission Control Protocol (“TCP”). The Internet supports a large variety of information-transfer protocols, and the web represents one of these. Web-accessible information is identified by a URL, typically with the format described above.

Data exchange is typically effected over the web by means of web pages. In this case, the mass storage device 106 contains various aspects of the site web pages. These aspects include, for example, formatting or mark-up instructions and associated data, and “applet” instructions that cause a properly equipped remote device, such as a computer, to present a dynamic display.

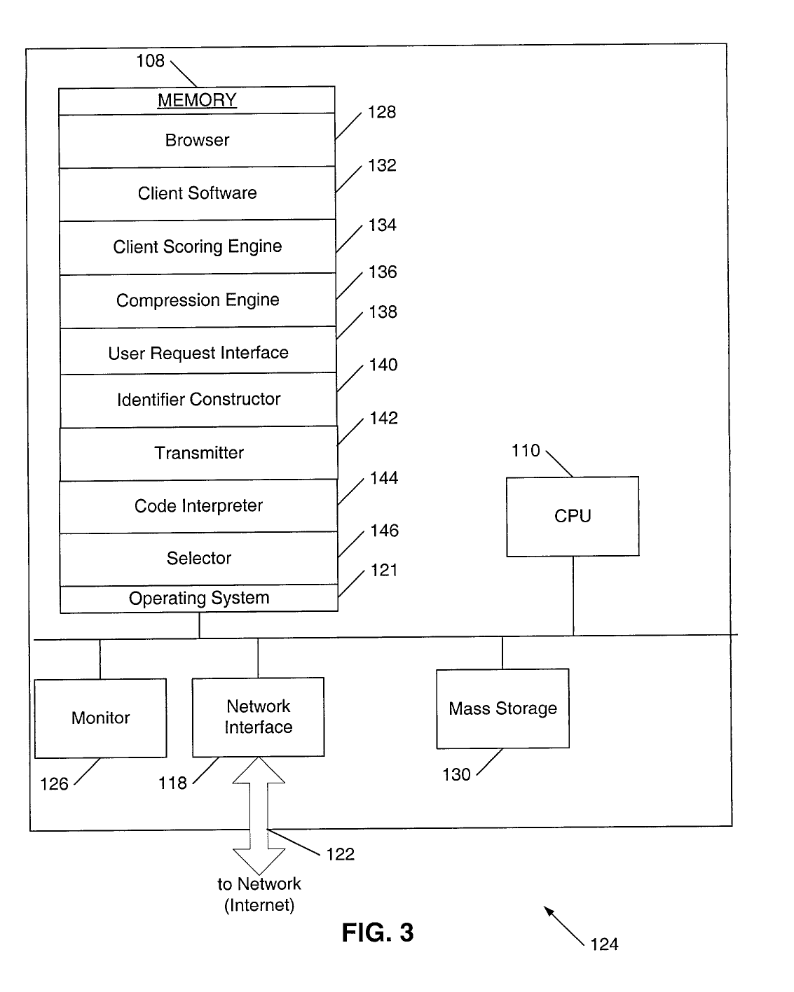

FIG. 3 is a block diagram depicting components found in client 124 and configured in accordance with the present invention. Client 124 is configured with like functional components described and similarly numbered in FIG. 2 for server 102. In memory 108 on client 124 in FIG. 3, however, client 124 includes a browser component 128, a client software component 132, a client scoring engine 134, a compression engine 136, a user request interface 138, an identifier constructor 140, a transmitter 142, a code interpreter 144 and a selector 146 running under the control and management of operating system 121.

Typically, a request for information by the client 124 is fulfilled using client software 132. The client software 132 constructs an identifier, in one embodiment in the form of a URL, and transmits the URL to the server 102 over the Internet 120. After receipt of this information, the server 102 first checks if it has a copy of that web page (i.e., a “cached copy”) to be transmitted to the client 124. If a cached copy is not present, the server 102 transmits to the web site defined by the identifier (i.e., the URL), over the Internet 120, a request for a copy of the particular web page. Alternatively, if a cached copy is not present, the client can request for a copy of the particular web page. This is accomplished by the server 102 transmitting to the client 124 a pointer to the web site defined by the identifier (i.e., the URL). Using this pointer, the client then requests the particular web page from the web site via the Internet 120.

The process by which the server 102 locates the web page for transmission to the client 124 includes mapping the initial request for information to a target URL. A mapping engine 112, operating in conjunction with the web server software 116, performs this task. The mapping engine 112 receives the request for information and then constructs a new, target URL that defines the particular web page for retrieval and delivery to the client 124. Methods by which the mapping engine 112 constructs the target URL are disclosed in the aforementioned applications incorporated herein by reference. In brief, these methods include extracting data from the identifier to generate a file name and path of a file stored on the server 102. This file typically includes the target URL that the server 102 transmits to the client 124.

In one embodiment, the server 102 “personalizes” the web page to be transmitted to the client 124. This personalization includes accessing and interpreting data specific to the end user, such as demographics, that is typically embedded in the identifier. The server 102 uses the data to, for example, augment the web page to be transmitted to the client 124. Alternatively, the server 102 uses the data to select a unique web page to be transmitted to the client 124. In one embodiment, the data are interpreted by mathematical manipulation to calculate a “score” that represents a profile of the end user. A server scoring engine 114, functioning with the web server software 116, performs this task. The mapping engine 112 then uses the value of the score to, for example, augment or select the web page to be transmitted to the client 124.

If the web page corresponding to the target URL cannot be located, an error handling system 115 (as described below) operates with the web server software 116 to provide the end user with alternative content. In one embodiment, the error handling system 115 selects alternative content that is related to the end user's request for information. This minimizes the potential of the end user receiving information that is not relevant to his initial request. To illustrate, assume the end user has requested information on a telephone manufacturer's particular model of wireless telephone. If the web page associated with the particular model cannot be located, the error handling system 115 then provides the end user with alternative content. This alternative content can include, for example, a web page that provides an overview of all wireless telephones produced by the telephone manufacturer. Thus, the end user receives information that is at least related to his initial request.

The data embedded in the initial request for information typically represent end user specific data, such as demographics. To increase the amount data sent to the server 102 without unduly burdening the network, the client 124 also includes a compression engine 136 that functions with (or may be part of) the client software 132. The compression engine 136 operates on the data before it is embedded in the initial request for information sent to the server 102. A purpose of the compression engine is to compress the data before including it in the initial request, thereby increasing the efficiency of the transmission. Furthermore, by providing additional end user specific data beyond the minimum amount needed to tailor the particular web page, the server 102 can increase the degree to which it tailors the particular web page.

In a different configuration, the client 124 includes a client scoring engine 134 that functions with (or may be part of) the client software 132. Typically operating on end user specific data, the client scoring engine 134 modifies the initial request for information before the client 124 sends it to the server 102. These modifications help define the particular web page, performing a function akin to that performed by the server scoring engine 114, and eliminates the need for or increasing the effectiveness of the latter.

The client 124 receives from the server 102 via the Internet 120 the target URL or the alternative content provided by the error handling system 115. The client 124 typically includes a monitor 126 and a mass storage 130. A browser 128 running on the client 124 receives the transmission from the server 102 and displays a representation of the particular web page or the alternative content on the monitor 126.

A client connection 122 between the Internet 120 and the client 124, as well as the server connection 119 between the server 102 and the Internet 120, may take many forms. Typical examples include high-speed dedicated lines, a wireless link, as well as simple dial-up connections. With respect to a wireless link, a wireless client such as a personal digital assistant (“PDA”) or wireless communication device is able to receive the benefit of the invention. It should also be noted that communication between the server 102 and the client 124 may be performed over a medium other than the Internet 120 as shown in FIG. 1. Any network, such as an intranet or other proprietary communications medium may substitute for the Internet 120 and still remain within the scope of the present invention.

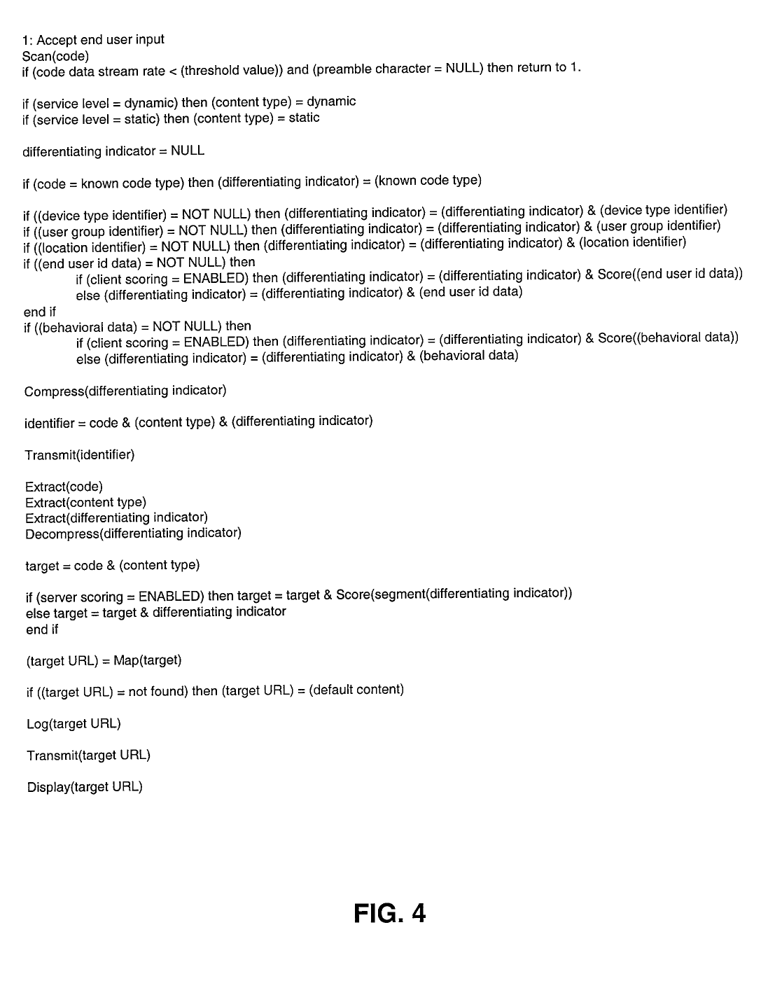

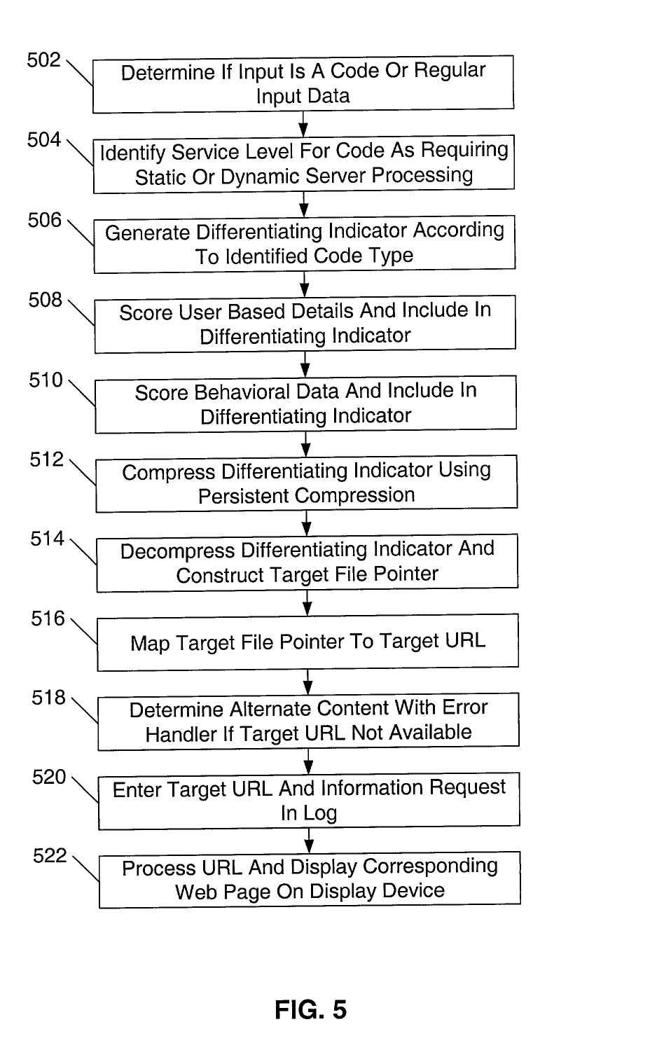

In brief overview, FIG. 4 depicts pseudo-code associated with one embodiment of the invention useful when developing software and FIG. 5 provides a corresponding flowchart of the operations associated with this example embodiment described in pseudo-code.

In FIG. 5, the client accepts data from the end user and examines it to determine if it represents a (scanned) code associated with an article of commerce (step 502). This determination is based on the rate at which the data is read and the presence of a preamble character in the data stream. If the rate is below a threshold value and the preamble character is not present, the client does not process the end user input as a code. Conversely, if the client determines the data does represent a code, the client then determines the appropriate service level (step 504). This is either “static” or “dynamic” and the client can make the determination based on the code itself.

In the next series of steps detailed in FIG. 5, the client generates a differentiating indicator based on various parameters known by or provided to the client. Initially, the client compares the format of the code with the formats of known code types (e.g., UPC or ISBN codes). If the client determines the code matches a known code type, then the code type information is included in the differentiating indicator (step 506). Other parameters added to the differentiating indicator include a device type identifier (identifying the hardware in use), a user group identifier (identifying a group or class of end users), a location identifier (identifying a physical or geographic location), end user identification data (step 508), and end user behavioral data (step 510). Optionally, the client can score the end user identification data and the end user behavioral data as described herein. In this case, the client includes the score in the differentiating indicator.

After generating the differentiating indicator, the client then compresses it using the persistent compression technique described herein (step 512). The client then constructs an identifier by combining the code, content type, and differentiating indicator, and then transmits this identifier to the server.

After receipt of the identifier, the server extracts the code, content type, and differentiating indicator. The server then decompresses the differentiating indicator and constructs a target file pointer (step 514). Alternate embodiments that use the compressed differentiating indicator directly do not require decompression and instead use the differentiating indicator to immediately construct the target file pointer. This target file pointer includes the code and the content type. Optionally, if the server is performing a scoring operation in lieu of the client, then the server selects the proper segment of the differentiating indicator to score. This segment includes, for example, the end user identification data, or the end user behavioral data, or both. The server then includes the score in target file pointer. Alternatively, if the server is not performing scoring, then the differentiating indicator itself is included in the target file pointer.

The server then maps the target file pointer to a target URL using, for example, methods described in the aforementioned applications incorporated herein by reference (step 516). If the target URL is not found, then an error handling system present on the server identifies alternative content (i.e., default content) that the server will provide to the end user (step 518). The server then redefines the target URL to associate it with the default content.

The server logs the information request and includes the target URL in the logged data (step 520). The server then transmits the target URL to the client. A browser program executing on the client receives the target URL and displays the associated web page for viewing by the end user (step 520).

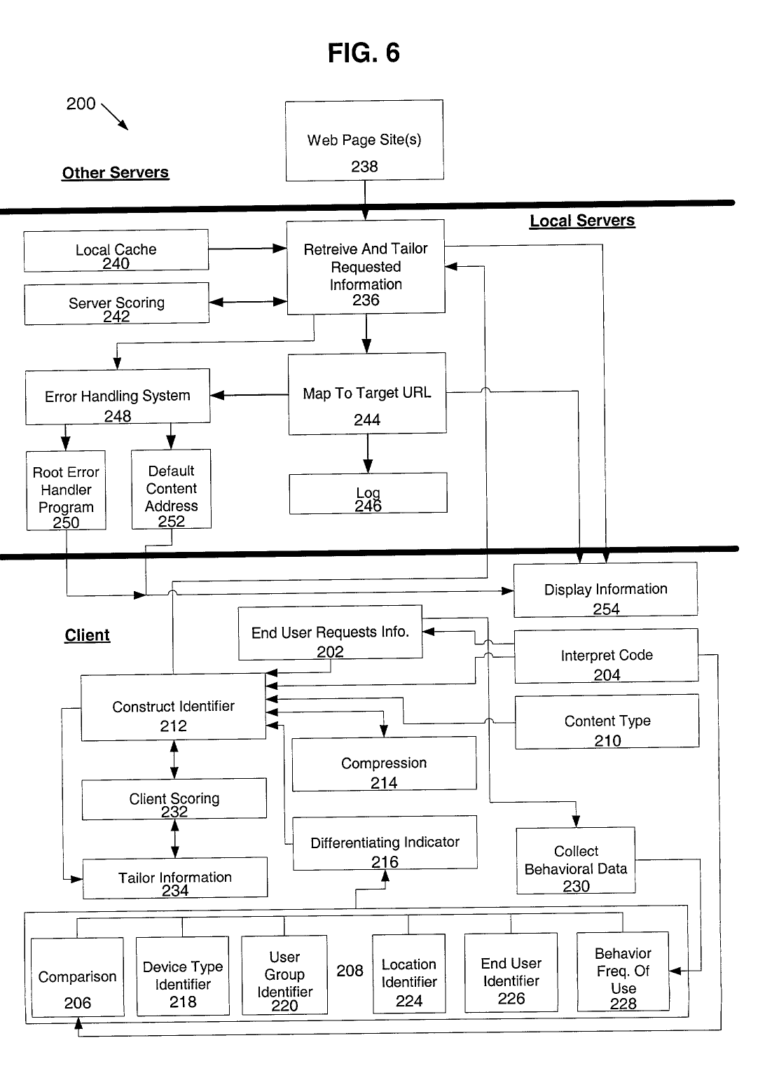

FIG. 6 is a block diagram of operations performed on local servers, client and other servers. Details of these operations in FIG. 6 are provided in the various flowchart diagrams described later herein as indicated below.

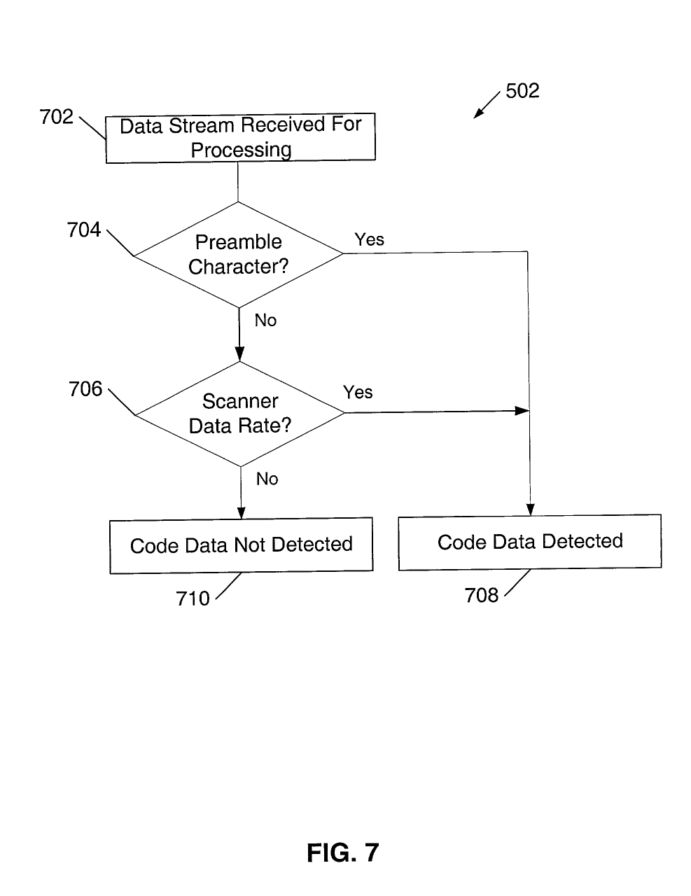

FIG. 7 provides a flowchart diagram of the operations used to determine if an input stream is a scanned code or regular input. Initially, the client accepts a request for information from an end user. This information typically is to be delivered to the end user in the form of a web page. Optionally, the client can accept the request for information by detecting and interpreting a code associated with an article of commerce 204. This code, which can be placed on or in the article or its packaging, is detected and interpreted by using, for example, optical, radio frequency, magnetic, or other scanning techniques known in the art. Data related to this code, or the code itself, is then included in the request for information.

When the code is detected and interpreted 204 in FIG. 7, a data stream representing the code is typically generated by, for example, a scanning device used to read the code (step 702). In one embodiment, this data stream is accepted and examined to determine (step 704) the presence of at least one preamble character. The preamble character is typically used to signify the boundaries (i.e., the start, end, or both) of the code data (step 708). The data stream rate is also determined (step 706). This rate is related to the speed at which the code is scanned. If the preamble is not detected and the rate is below the expected rate of the scanner device then a code is generally not present or may go undetected (step 710).

The presence of a preamble character or a data stream rate exceeding that typically achieved by manual entry (e.g., by typing on a keyboard) generally signifies the presence of code data, not data from another source, such as a keyboard. This determination is necessary as it is not uncommon for the data stream to use a transmission medium shared by other devices. For example, the scanning device and a computer keyboard may share a common data input port on the client. In this case, the client may have difficulty discriminating between data originating from the keyboard and data originating from the scanning device. Data from each of these sources typically require different processing, and the inability of the client to discern the origin of the data can lead to improper or unexpected operation of software executing on the client. This interpretation step 204 looks for these attributes and thus classifies the data stream according to its origin. This ensures the data receives the proper processing, thereby increasing operational accuracy.

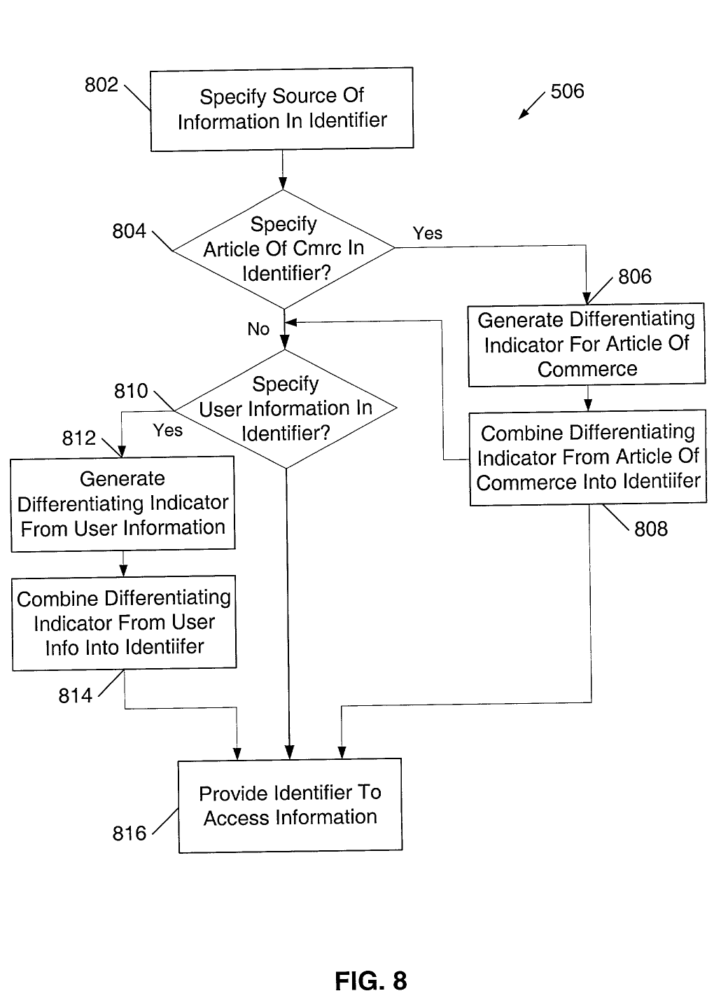

Referring to FIG. 8, a flow chart diagram provides the operations associated with generating an identifier having differentiating indicators. In this embodiment, the client specifies a source of the information requested by the end user and includes a differentiating indicator in the identifier (step 802). This identifier typically includes a URL.

If an article of commerce having a code is used (step 804), the identifier can also include the code associated with an article of commerce (step 808). Generating the differentiating indicator is achieved as described in the aforementioned related patents and as described later herein (step 806).

By combining the URL with end user specific data 208 resident on the client, the client creates the differentiating indicator 216, and then incorporates the differentiating indicator into the identifier.

Alternatively, the differentiating indicator can also include information specific to the end user (step 810), or hardware involved, or both. Examples include a device type identifier 218, which distinguishes the client hardware in use, and a location identifier 224, which designates its physical or geographic location. The differentiating indicator can also include end user identification data 226 (step 814). Furthermore, end users can be categorized or aggregated in to specific user groups, and the differentiating indicator can include a corresponding user group identifier 220 (step 812).

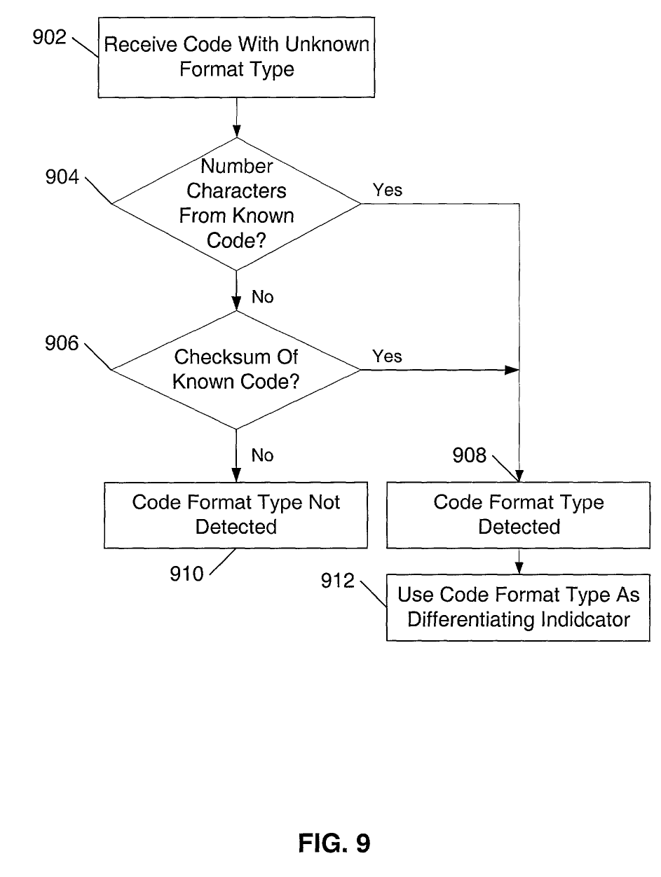

FIG. 9 provides the operations associated with distinguishing between the various types of codes associated with an article of commerce. The client compares a received code with one or more known code types (e.g., formats) 206. The client receives the code using, for example, a scanner as described above or by manual entry by the end user's use of an input device, such as a keyboard. Typical known code types include the UPC and ISBN formats, each of which has a standardized representation.

Initially, a client receives a code with an unknown or unidentified code type (step 902). The client performs the comparison by comparing the number of characters in the received code with the number of characters found in known code types (step 904). If the number of characters match, a code format type may be detected (step 908). Alternatively, the client can perform the comparison by comparing the checksum of the received code with the checksum associated with known code types (step 906). When the comparison reveals a match to a known code type, that code type is defined to be the differentiating indicator (912). If the comparisons do not reveal a match, the code type remains undetected, is not a known code type or is invalid data/code(step 910).

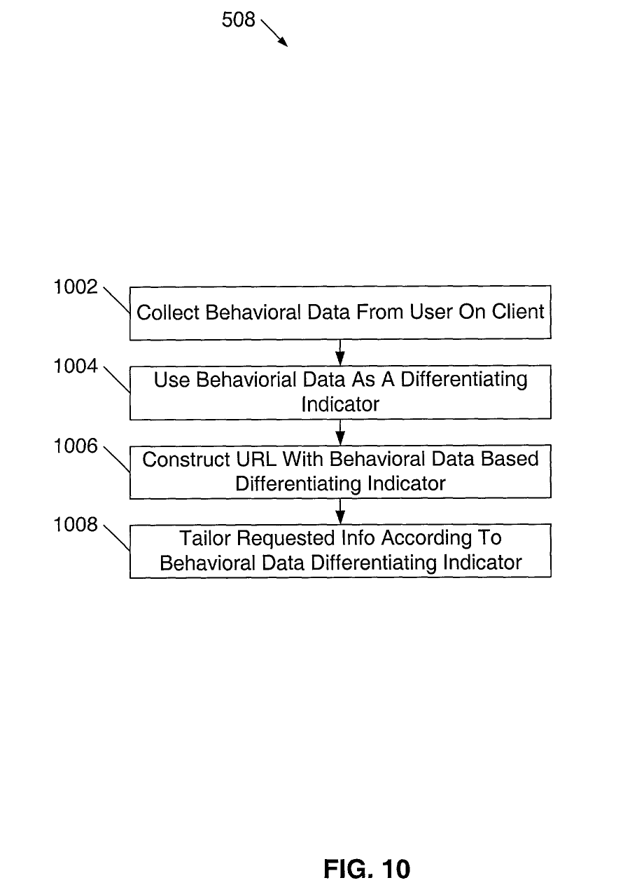

FIG. 10 is a flowchart diagram providing the operations associated with using behavioral data to tailor the response to a request for information. Initially, a client collects behavioral data based on an end user's activity 230 (step 1002) and include it in the differentiating indicator 228 (step 1004). The behavioral data incorporates, for example, the frequency at which an end user's requests for information use a specific code. Various codes may also be categorized. Consequently, the frequency at which a specific code category is used in an end user's requests for information may be included in the behavioral data. For example, consider a case where there are three specific codes, “C 1”, “C2”, and “C3”. Assume the behavioral data collected by the client reveals the end user has made five requests for information using code C1, ten requests using code C2, and thirteen requests using code C3. In one embodiment, the system then constructs a URL (step 1006) of the form:

http://<host>/<code>/<path>/<filename>?&5&10&13

In this URL, <host> and <path> are as defined above, <filename> is the name of the file to be accessed, and <code> refers to the code associated with the request for information (e.g., a code associated with an article of commerce). The characters following the question mark (i.e., a delimiter) are the frequencies of code use, positionally encoded within the URL.

After constructing the identifier 212, the client transmits it as a URL to a local server that retrieves and tailors the requested information 236 (step 1008). The local server can retrieve a copy of the requested information from a local cache 240, if such a copy exists. Alternatively, the local server can obtain the requested information from one or more other servers 238.

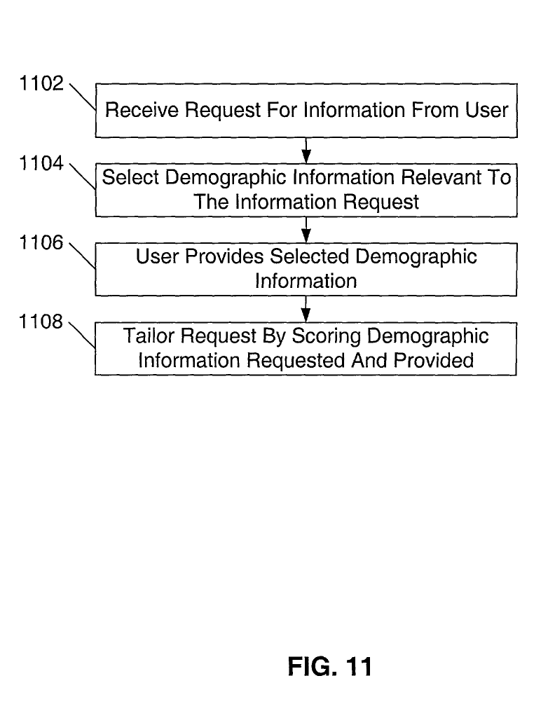

FIG. 11 is a flowchart diagram providing the operations associated with using demographic information to tailor requested information. In one implementation, the local server tailors (e.g., personalizes) the requested information typically by examining the differentiating indicator. In this example, the local server tailors the requested information (step 1102) by computing a score according to a predefined algorithm that operates on the differentiating indicator 242. The value of the score determines, at least in part, the information the local server selects to be returned (step 1104) to the end user in response to the request (step 1106). The scoring algorithm can be, for example, a linear model where each item of data included in the differentiating indicator has an associated statistical “weight” (step 1108).

In this model, each data item is multiplied by its associated weight and the resulting products are summed to calculate a score. To illustrate, consider the case where the differentiating indicator includes data (using, for example, the method of positional encoding described above) regarding the end user's demographics, such age and annual income. Assume the age of the end user is forty-five and his annual income is $ 100,000. For this example, further assume the age range of thirty to fifty is represented by the code “3” and the income by the code “8”. Lastly, assume the scoring algorithm is a linear model that gives a twenty percent weight to age and an eighty percent weight to annual income. Mathematically, this is represented by the equation S=0.2(3)+0.8(8)=7.0, where “S” is the computed score. Thus, by examining the differentiating indicator and computing a score, the server uses the latter to categorize the end user based on his demographic data. Consequently, the server selects information to fulfill the end user's request that is also appropriate for that end user's demographics. The server accomplishes this by selecting information based on the value of the score. Note that such scoring is not limited to operating on end user demographic data: the behavioral data described above may be similarly scored and the server may select information on this basis. In essence, scoring may be performed on virtually any amenable data included in the differentiating indicator, and the score used to select information in response to the end user's request.

The degree to which the requested information is tailored is generally influenced by the amount of demographic data available. Increasing the amount of demographic data present in the differentiating indicator is one way to enhance the tailoring. Nevertheless, including too much information in the differentiating indicator can burden the communication links between the local server and the client. This can degrade network performance, leading to reduced local server responsiveness and a corresponding increase in end user frustration.

In an alternative implementation, the client may perform substantially the same scoring function 232. In this case, the client includes the score within the identifier that it sends to the local server. Furthermore, the client, instead of the local server, may select the information to be returned to the end user 234. The client can base its selection on an examination of the score. The selection is reflected in the identifier constructed 212.

To minimize these problems without sacrificing the enhanced tailoring, an embodiment of the invention features a persistent compression technique. The technique is “persistent” because the compressed data (i.e., the output of the compression step 214) uses characters with byte sizes that do not expand when interacting with web servers. This expansion can occur, for example, if a web server uses a mechanism known as “URL encoding.” This mechanism, typically adopted as a security measure, causes certain characters to be translated in to others having larger byte sizes. Consequently, the efficacy of the compression is compromised. The persistent compression technique ensures the characters representing the compressed data are those resistant to expansion. These characters are typically alphanumeric and are used to represent, for example, numerical values that, in turn, represent the demographics. Because there are fewer alphanumeric characters than a range of values, the values are typically scaled by dividing by a base divisor. The quotient is associated with a non-expanding alphanumeric character.

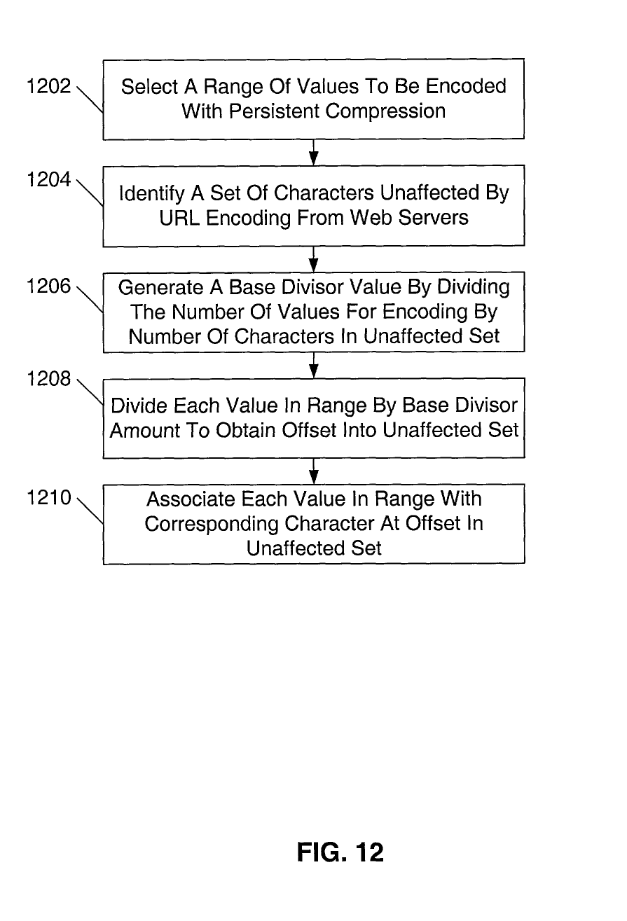

FIG. 12 is a flowchart diagram of the steps for performing persistent compression. To illustrate, consider the case where values between 0 and 999 are to be encoded (step 1202). Assume there are fifty available alphanumeric characters (e.g., the alphabet “A” through “Y”, both upper and lower case) available that are unaffected by URL encoding (step 1204). Dividing the number of values (1000) by fifty yields the base divisor, twenty (step 1206). Each value to be encoded is divided by the base divisor (step 1208) and the integer portion of the quotient is translated in to the corresponding alphanumeric character (step 1210). For example, to encode the value “991”, the value is first divided by the base divisor (twenty) to yield an integer quotient of “49”. Assume the letter “a” corresponds to “0”, the letter “b” to “1”, the letter “y” to 24, the letter “A” to 25, the letter “B” to 26 , the letter “Y” to 50, etc. Thus, “991” is encoded as the letter “X”. Furthermore, certain characters may be reserved to signify “large”, “small” and “undefined” values. Thus, with knowledge of the base divisor, the local server can decompress the data and reconstitute the appropriate values. Note that because the integer portion is of the quotient is encoded, the local server may not be able to reconstitute the exact value. To illustrate using the example above, the local server would multiply the value corresponding to “X” (49) by the base divisor (20), yielding 980. Although this is not equal to the original data (991), the deviation may not be significant, particularly when the data are categorized into various ranges (e.g., 20 through 40, 250 through 275, etc.). This is not uncommon when the data represents demographics.

In this embodiment, supplementary data, such as demographics, are compressed using the persistent compression technique 214 and included in an identifier, such as a URL, that the client constructs 212. This identifier with the compressed supplementary data is then transmitted to the server.

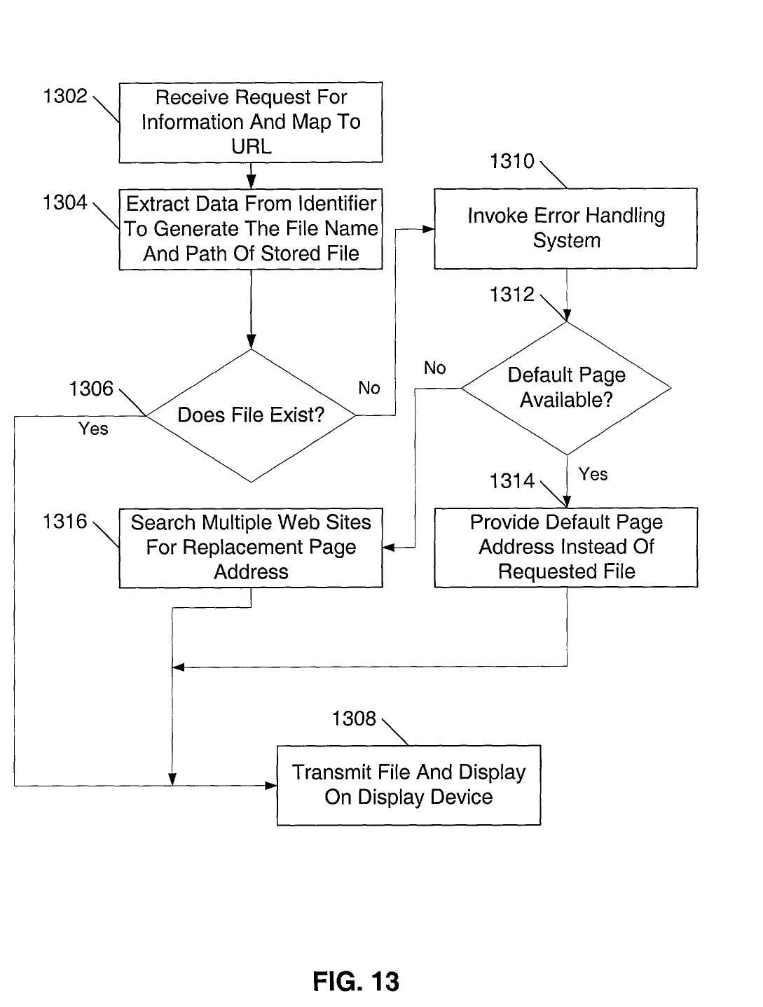

FIG. 13 is a flowchart diagram of the operations used to map a request for information to a URL. In this implementation, local server receives the end user's request for information (step 1302) and maps it to a target URL 244, tailored as described above. Mapping 244 typically uses methods disclosed in the aforementioned applications incorporated herein by reference. Briefly, these methods include extracting data from the identifier constructed 212 to generate the file name and path of a file stored on the local server (step 1304). This file (the “pointer file”) typically contains the target URL.

This target URL is associated with a target file (e.g., the web page corresponding to the target URL) (step 1304). If this target file exists (step 1306), it is transmitted from the local server to the client and displayed 254 for the end user (step 1308).

If the pointer file, the target file, or both do not exist or cannot be found, the local server accesses an error handling system 248 (step 1310). The error handling system intercepts any server-generated error and defines the target URL to correspond to a default content address 252 (step 1312). In this way, default content (e.g., another web page known to exist) is provided to the end user in the place of a display of the error condition (step 1314).

Alternatively, the error handling system can execute a root error handler program 250. This program systematically searches for a number of different web sites to transmit to the client to replace that site represented by the target URL (step 1316). The output of the root error handler program includes a URL that defines the replacement site. Irrespective of the method used, an objective of executing the error handling system 248 is to shield the end user from error conditions that would likely cause considerable frustration. Furthermore, the error handling system and the root error handler program may be configured to identify the default content and the replacement site, respectively, that are related to the end user's request. This minimizes the presentation of irrelevant material to the end user on a display device (step 1308).

A variation of this embodiment features the client accepting the end user's request for information 202, constructing the identifier that specifies a source of the information 212, and transmitting the identifier to the local server that locates the information based on the identifier 236. The differentiating indicator can optionally be included in the identifier 216. The error handling system is accessed when the server fails to locate the information based on the identifier 248. This includes the use of the default content address 252 or the execution of a root error handler program 250, both described above. Conversely, when the server locates the information based on the identifier, it transmits that information to the server.

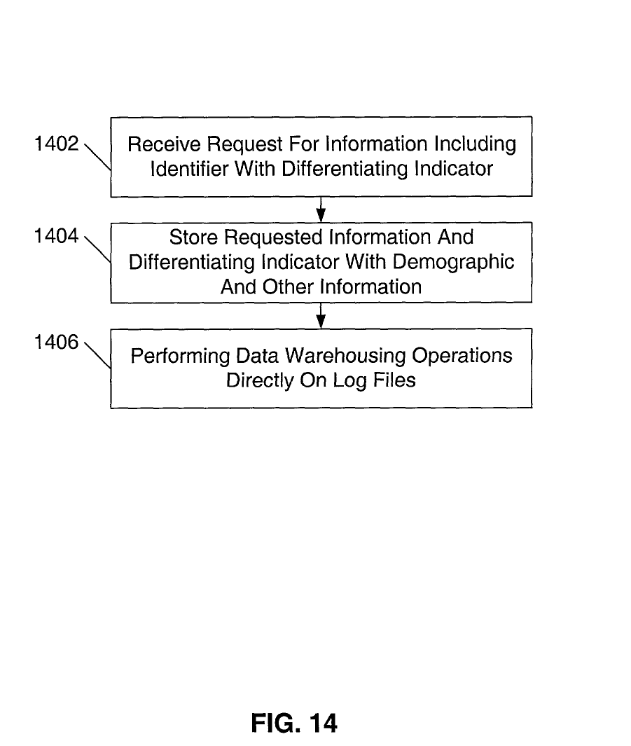

FIG. 14 is a flowchart diagram of the operations used for entering logs and datamining the information in the logs. For each request for information from a user, the local server logs (i.e., stores) the requests for information 246. This is typically done in conjunction with the mapping step 244, when the target URL is determined. In brief, when the client transmits its request for information to the local server (step 1402), the response of the latter typically includes a “header” that has data regarding the exchange with the client. (An example of this is the header generated by the Apache Web Server software.) The local server is configured to eliminate certain items from the header and replace them with other data, including the target URL 244 determined. The local server is further configured to extract specific items (i.e., log a portion of these header response), such as the target URL, from this header and insert them into a log file (step 1404) that the local server maintains. This log file can be examined to assess, for example, the type, nature, and frequency of requests for information, thereby providing a “data warehousing” functionality (step 1406).

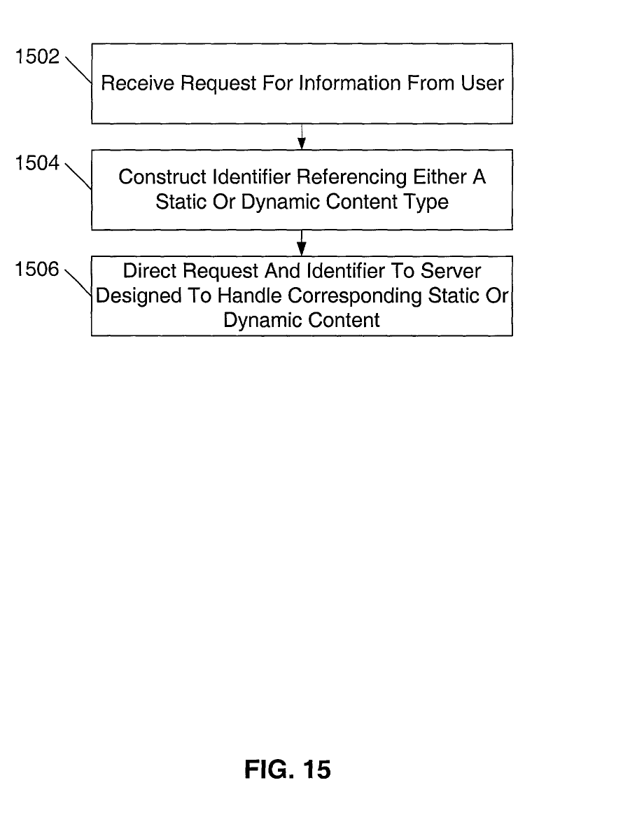

FIG. 15 is a flowchart diagram illustrating the operations associated with selecting the service level provided by a server to a client. Service level is defined, at least in part, by a content type. A content type pertains to the target URL, and is typically “static” or “dynamic”. This reflects the nature of the web page associated with the target URL (i.e., a static or dynamic web page). In this embodiment, the client accepts a request for information from an end user 202 (step 1502), selects a content type 210, and constructs an identifier 212 (step 1504) that includes a designator that specifies the content type. The identifier typically includes a URL. The client can determine this designator, which can further be determined, at least in part, by a code associated with an article of commerce.

The identifier with the included designator is then transmitted to the local server, which, in turn, executes program instructions based on the designator (step 1506). These program instructions cause the local server to provide the selected content type (e.g., static or dynamic). The program instructions trigger the delivery of a static web page, or initiate the execution of one or more programs to provide the dynamic content. The information requested by the end user is then transmitted from the local server to the client using the selected content type.

Under certain conditions, it may be desirable to encrypt some or all of the identifier constructed 212 before its transmission to the local server. The client can perform the encryption 212. Alternatively, already encrypted data, such as an already encrypted code associated with an article of commerce that is part of the request for information, may be included within the identifier for transmission, as is, to the local server. The local server then maps the encrypted identifier to a target URL 244, and this is typically done without decryption. The local server then transmits the target URL to the client to display the associated target file for the end user 254.

In some instances, the target URL may correspond to an online form that the end user would typically complete by entering, for example, personal identifying data. Typically, an online form is responsive to data contained in its URL. This means the online form extracts data included in its URL and inserts that data into the corresponding fields or locations in the online form (i.e., “populates” the form). For example, characters representing the end user's name may be included in the URL. The online form then extracts those characters and, after performing any required processing, inserts them into a “name” field or location in the online form. Consequently, data to complete the online form are transferred into the latter without the need for the end user to enter the information. This streamlines the end user's interaction with the online form.

When the differentiating indicator (which is part of the identifier) includes the end user identification data 226, the latter can be extracted from the identifier and inserted into the target URL. Thus, when the target URL corresponds to an online form, responsive as described above, the end user identification data 226 populate the corresponding fields or locations in the form. Note that the online form may call for a particular format for the end user identification data 226. In this case, the local server reformats the latter as required after extracting it from the identifier and before inserting it into the target URL.

Although embodiments of the invention are described above as combinations of various discrete operations or elements, actual implementations of the invention may include or exclude additional operations and be inseparable components of other electronic devices such as a digital computer. Accordingly, the invention can be implemented in digital electronic circuitry, or in computer hardware, firmware, software, or in combinations of them. Apparatus of the invention can be implemented in a computer program product tangibly embodied in a machine readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

Consequently, another embodiment of the invention features a system to provide information from a server 102 to a client 124 in response to a request from an end user. In this system, the client 124 includes a user request interface 138 that receives the end user's request for information. An identifier constructor 140 communicates with the user request interface 138. This identifier constructor 140 assembles an identifier, typically a URL, that specifies a source of the requested information. The identifier constructor 140 inserts a differentiating indicator in the identifier. This differentiating indicator, as described above, includes information specific to the end user, the hardware involved, or both. The client 124 also includes a transmitter 142 that is in communication with the identifier constructor 140. The transmitter 142 then sends the identifier (with the included differentiating indicator) from the client 124 to the server 102.

In this embodiment, the server 102 includes an information tailoring apparatus 111 that, in response to the differentiating indicator, tailors (i.e., personalizes) the information that will be provided to the end user. The server has a transmitter 113 that is in communication with the information tailoring apparatus 111 and the client 124. The transmitter 111 sends the information from the server 102 to the client 124 for display for the end user.

In a different embodiment, the client 124 includes a code interpreter 144 that accepts a request for information from an end user. It accomplishes this by interpreting a code associated with an article of commerce. This code is as described above. An identifier constructor 140 communicates with the code interpreter 144 and assembles an identifier. Optionally, the identifier can be encrypted. The identifier includes the code associated with an article of commerce. A transmitter 142 sends this identifier to the server.

After the server 102 receives the identifier, a mapping engine 112 maps it to a target URL. Mapping is accomplished using the techniques described herein. The server 102 then transmits the target URL to the client using a transmitter 113 that is in communication with the mapping engine 112 and the client 124.

The server 102 can also include a usage monitor 117 that is in communication with the mapping engine 112. As requests for information are made of the server 102, this usage monitor 117 logs at least a portion of the server header response to these requests. The server 102 uses a locator 109 to find the information that the end user requested. In some instances, the server 102 may be unable to locate this information. To address such situations, the server 102 includes an error handling system 115 that is in communication with the locator 109. The error handling system 115 executes an error handling routine that provides the end user with alternative content when the requested information is not available or cannot be found. The server 102 includes a transmitter 113 that is in communication with the locator 109 and the client 124. The transmitter 113 sends the client 124 the requested information (if the latter is located) and the alternative content (if the requested information cannot be located).

In a different embodiment, the client 102 includes a selector 146 that is in communication with the user request interface 138. The selector 146 chooses either a static or a dynamic content type. The identifier constructor 140 constructs an identifier that includes a designator that specifies the content type. When the server 124 receives the identifier, it executes program instructions depending on the designator (e.g., different instructions corresponding to a static content type versus different instructions corresponding to a dynamic content type).

The client 124 can also include supplementary data in its request for information from the server. A compression engine 136 that is in communication with the identifier constructor 140 compresses this supplementary data. The persistent compression technique described above is used.

From the foregoing, it will be appreciated that the methods provided by the invention afford a simple and effective way to locate information on a network, such as the Internet, that is of interest and tailored to an end user. The problem of an end user being unable to locate such information from large volume of data expeditiously is largely eliminated.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of providing information from a server to a client, the method comprising the steps of:
accepting, by the client, a request for information from a user;
constructing, by the client, an identifier that specifies a source of the information, the identifier including a differentiating indicator;
transmitting, by the client, the identifier with the included differentiating indicator to the server;
tailoring, by the server, the information based on the differentiating indicator; and
transmitting, by the server, the information from the server to the client.

2. The method of claim 1 wherein the identifier comprises a Uniform Resource Locator.

3. The method of claim 1 wherein the differentiating indicator comprises at least one of a device type identifier, a user group identifier, and a location identifier.

4. The method of claim 1 wherein the step of accepting a request for information further comprises the step of interpreting a code associated with an article of commerce.

5. The method of claim 4 wherein the step of interpreting a code associated with an article of commerce further comprises the steps of:
accepting a data stream;
determining the presence of at least one preamble character in the data stream;
determining a data stream rate; and
classifying the data stream as the code associated with an article of commerce based on at least one of the data stream rate and the presence of the at least one preamble character.

6. The method of claim 4 wherein the identifier includes the code associated with an article of commerce.

7. The method of claim 6 wherein the step of transmitting the information from the server to the client further comprises the steps of:
mapping the identifier to a target Uniform Resource Locator; and
transmitting the target Uniform Resource Locator to the client.

8. The method of claim 7 wherein the mapping step further comprises the step of accessing an error handling system when an associated target file does not exist.

9. The method of claim 8 wherein the step of accessing an error handling system further comprises the steps of:
intercepting a corresponding server-generated error; and
defining the target Uniform Resource Locator to correspond to a default content address.

10. The method of claim 8 wherein the step of accessing an error handling system further comprises the steps of:
intercepting a corresponding server-generated error;
executing a root error handler program; and
defining the target Uniform Resource Locator to correspond to an output of the root error handler program.

11. The method of claim 7 wherein the differentiating indicator comprises user identification data.

12. The method of claim 11 wherein the target Uniform Resource Locator includes the user identification data, the target Uniform Resource Locator corresponding to an online form that is responsive to the user identification data.

13. The method of claim 4 wherein the step of constructing an identifier further comprises the steps of:
comparing the code associated with an article of commerce with at least one known code type; and
defining the differentiating indicator to be the at least one known code type that matches the code associated with an article of commerce.

14. The method of claim 13 wherein the step of comparing the code associated with an article of commerce with at least one known code type further comprises the step of comparing the number of characters in each.

15. The method of claim 13 wherein the step of comparing the code associated with an article of commerce with at least one known code type further comprises the step of comparing the checksum of each.

16. The method of claim 4 further comprising the step of collecting, by the client, of behavioral data based on a user's activity.

17. The method of claim 16 wherein the differentiating indicator comprises the behavioral data.

18. The method of claim 17 wherein the differentiating indicator comprises at least one of a user frequency of code use, and a user frequency of code category use.

19. The method of claim 1 wherein the tailoring step further comprises the steps of:
computing a score according to a predefined algorithm; and
selecting the information based, at least in part, on the value of the score.

20. The method of claim 19 wherein the step of computing a score occurs at the server.

21. The method of claim 19 wherein the step of computing a score occurs at the client.

22. The method of claim 19 wherein the step of selecting the information occurs at the server.

23. The method of claim 19 wherein the step of selecting the information occurs at the client.

24. A method of providing information from a server to a client, the method comprising the steps of:
accepting, by the client, a request for information from a user by interpreting a code associated with an article of commerce;
constructing, by the client, an encrypted identifier that specifies a source of the information, the encrypted identifier including the code associated with an article of commerce;
transmitting, by the client, the encrypted identifier to the server;
mapping the encrypted identifier to a target Uniform Resource Locator; and
transmitting, by the server, the target Uniform Resource Locator to the client.

25. A method of logging requests for information from a server to a client, the method comprising the steps of:
accepting, by the client, a request for information from a user by interpreting a code associated with an article of commerce;
constructing, by the client, an identifier that specifies a source of the information, the identifier including the code associated with an article of commerce;
transmitting, by the client, the identifier to the server;
mapping, by the server, the identifier to a target Uniform Resource Locator;
logging at least one portion of a server header response; and
transmitting, by the server, the target Uniform Resource Locator from the server to the client.

26. The method of claim 25 further comprising the step of causing the target Uniform Resource Locator to appear in the server header response.

27. A method of providing information from a server to a client, the method comprising the steps of:
accepting, by the client, a request for information from a user;
constructing, by the client, an identifier that specifies a source of the information;
transmitting, by the client, the identifier to the server;
locating, by the server, the information based on the identifier;
accessing an error handling system when the server fails to locate the information based on the identifier; and
transmitting, by the server, the information from the server to the client when the server locates the information based on the identifier.

28. The method of claim 27 wherein the step of accessing an error handling system further comprises the steps of:
intercepting, by the server, a corresponding server-generated error; and
transmitting, by the server, default content information from the server to the client.

29. The method of claim 27 wherein the step of accessing an error handling system further comprises the steps of:
intercepting, by the server, a corresponding server-generated error;
executing, by the server, a root error handler program; and
transmitting, by the server, default content information from the server to the client, the default content corresponding to an output of the root error handler program.

30. The method of claim 27 wherein the step of constructing the identifier further comprises the step of including a differentiating indicator within the identifier.

31. A method of selecting a service level provided by a server to a client, the method comprising the steps of:
accepting a request for information from a user;
selecting, by the client, a content type;
constructing an identifier that specifies a source of the information;
including within the identifier a designator specifying the content type;
transmitting the identifier with the included designator to the server; and
executing, on the server, program instructions based on the designator.

32. The method of claim 31 wherein the program instructions cause the server to provide the selected content type.

33. The method of claim 32 further comprising the step of transmitting the information from the server to the client using the selected content type.

34. The method of claim 31 wherein the identifier comprises a Uniform Resource Locator.

35. The method of claim 31 wherein the content type comprises a static content.

36. The method of claim 31 wherein the content type comprises a dynamic content.

37. The method of claim 31 wherein the designator is determined by the client.

38. The method of claim 37 wherein the designator is determined at least in part from a code associated with an article of commerce.

39. A method of including supplementary data in a request for information from a server, the method comprising the steps of:
constructing an identifier that specifies a source of the information;
compressing the supplementary data using a persistent compression;
including the compressed supplementary data within the identifier; and
transmitting the identifier with the included compressed supplementary data to the server.

40. The method of claim 39 wherein the identifier comprises a Uniform Resource Locator.

41. An article of manufacture comprising a program storage medium having computer readable program code embodied therein for causing a server to provide information to a client, the computer readable program code in the article of manufacture including:
computer readable code for causing a computer to accept a request for information from a user;
computer readable code for causing a computer to construct an identifier that specifies a source of the information, the identifier including a differentiating indicator;
computer readable code for causing a computer to transmit the identifier with the included differentiating indicator to the server;
computer readable code for causing a computer to tailor the information based on the differentiating indicator; and
computer readable code for causing a computer to transmit the information from the server to the client, so as to deliver tailored information to the user.

42. A program storage medium readable by a computer, tangibly embodying a program of instructions executable by the computer to perform method steps for causing a server to provide information to a client, the method steps comprising:
accepting a request for information from a user;
constructing an identifier that specifies a source of the information, the identifier including a differentiating indicator;
transmitting the identifier with the included differentiating indicator to the server;
tailoring the information based on the differentiating indicator; and
transmitting the information from the server to the client, so as to deliver tailored information to the user.

43. An article of manufacture comprising a program storage medium having computer readable program code embodied therein for causing a server to provide information to a client, the computer readable program code in the article of manufacture including:
computer readable code for causing a computer to accept a request for information from a user by interpreting a code associated with an article of commerce;
computer readable code for causing a computer to construct an encrypted identifier that specifies a source of the information, the encrypted identifier including the code associated with an article of commerce;
computer readable code for causing a computer to transmit the encrypted identifier to the server;
computer readable code for causing a computer to map the encrypted identifier to a target Uniform Resource Locator; and
computer readable code for causing a computer to transmit the target Uniform Resource Locator from the server to the client, so as to deliver the information to the user.

44. A program storage medium readable by a computer, tangibly embodying a program of instructions executable by the computer to perform method steps for causing a server to provide information to a client, the method steps comprising:
accepting a request for information from a user by interpreting a code associated with an article of commerce;
constructing an encrypted identifier that specifies a source of the information, the encrypted identifier including the code associated with an article of commerce;
transmitting the encrypted identifier to the server;
mapping the encrypted identifier to a target Uniform Resource Locator; and
transmitting the target Uniform Resource Locator to the client, so as to deliver the information to the user.

45. An article of manufacture comprising a program storage medium having computer readable program code embodied therein for causing a computer to log requests for information from a server to a client, the computer readable program code in the article of manufacture including:
computer readable code for causing a computer to accept a request for information from a user by interpreting a code associated with an article of commerce;
computer readable code for causing a computer to construct an identifier that specifies a source of the information, the identifier including the code associated with an article of commerce;
computer readable code for causing a computer to transmit the identifier to the server;
computer readable code for causing a computer to map the identifier to a target Uniform Resource Locator;
computer readable code for causing a computer to log at least one portion of a server header response; and
computer readable code for causing a computer to transmit the target Uniform Resource Locator from the server to the client, so as to deliver information to the user.

46. A program storage medium readable by a computer, tangibly embodying a program of instructions executable by the computer to perform method steps for causing a computer to log requests for information from a server to a client, the method steps comprising:
accepting a request for information from a user by interpreting a code associated with an article of commerce;
constructing an identifier that specifies a source of the information, the identifier including the code associated with an article of commerce;
transmitting the identifier to the server;
mapping the identifier to a target Uniform Resource Locator;
logging at least one portion of a server header response; and
transmitting the target Uniform Resource Locator to the client, so as to deliver information to the user.

47. An article of manufacture comprising a program storage medium having computer readable program code embodied therein for causing a server to provide information to a client, the computer readable program code in the article of manufacture including:
computer readable code for causing a computer to accept a request for information from a user;
computer readable code for causing a computer to construct an identifier that specifies a source of the information;
computer readable code for causing a computer to transmit the identifier to the server;
computer readable code for causing a computer to locate the information based on the identifier;
computer readable code for causing a computer to access an error handling system when the server fails to locate the information based on the identifier; and
computer readable code for causing a computer to transmit the information from the server to the client when the server locates the information based on the identifier, so as to deliver the information to the user.

48. A program storage medium readable by a computer, tangibly embodying a program of instructions executable by the computer to perform method steps for causing a server to provide information to a client, the method steps comprising:
accepting a request for information from a user;
constructing an identifier that specifies a source of the information;
transmitting the identifier to the server;
locating the information based on the identifier;
accessing an error handling system when the server fails to locate the information based on the identifier; and
transmitting the information from the server to the client when the server locates the information based on the identifier, so as to deliver the information to the user.

49. An article of manufacture comprising a program storage medium having computer readable program code embodied therein for selecting a service level provided by a server to a client, the computer readable program code in the article of manufacture including:
computer readable code for causing a computer to accept a request for information from a user;
computer readable code for causing a computer to select a content type;
computer readable code for causing a computer to construct an identifier that specifies a source of the information;
computer readable code for causing a computer to include within the identifier a designator specifying the content type;
computer readable code for causing a computer to transmit the identifier with the included designator to the server; and
computer readable code for causing a computer to execute program instructions based on the designator, so as to select the service level.

50. A program storage medium readable by a computer, tangibly embodying a program of instructions executable by the computer to perform method steps to select a service level provided by a server to a client, the method steps comprising:
accepting a request for information from a user;
selecting a content type;
constructing an identifier that specifies a source of the information;
including within the identifier a designator specifying the content type;
transmitting the identifier with the included designator to the server; and
executing program instructions based on the designator.
transmitting the information from the server to the client using the selected content type, so as to select the service level.

51. An article of manufacture comprising a program storage medium having computer readable program code embodied therein for including supplementary data in a request for information from a server, the computer readable program code in the article of manufacture including:
computer readable code for causing a computer to construct an identifier that specifies a source of the information;
computer readable code for causing a computer to compress the supplementary data using a persistent compression;
computer readable code for causing a computer to include the compressed supplementary data within the identifier; and
computer readable code for causing a computer to transmit the identifier with the included compressed supplementary data to the server, so as to provide the server with the compressed supplementary data.

52. A program storage medium readable by a computer, tangibly embodying a program of instructions executable by the computer to perform method steps to include supplementary data in a request for information from a server, the method steps comprising:
constructing an identifier that specifies a source of the information;
compressing the supplementary data using a persistent compression;
including the compressed supplementary data within the identifier; and
transmitting the identifier with the included compressed supplementary data to the server.

53. A system to provide information from a server to a client in response to a request from a user, the system comprising:
a client comprising:
a user request interface;
an identifier constructor in communication with the user request interface, the identifier constructor constructing an identifier that specifies a source of the requested information, the identifier including a differentiating indicator; and
a first transmitter in communication with the identifier constructor;
a server in communication with the client, the server comprising:
an information tailoring apparatus for tailoring the requested information in response to the differentiating indicator; and
a second transmitter in communication with the information tailoring apparatus and the client;
wherein the first transmitter transmits the identifier with the included differentiating indicator to the server and the second transmitter transmits the requested information to the client.

54. A system to provide information from a server to a client in response to a request from a user, the system comprising:
a client comprising:
a code interpreter;
an identifier constructor in communication with the code interpreter, the identifier constructor constructing an encrypted identifier that specifies a source of the requested information, the encrypted identifier including a code associated with an article of commerce; and
a first transmitter in communication with the identifier constructor;
a server in communication with the client, the server comprising:
a mapping engine for mapping the encrypted identifier to a target Uniform Resource Locator; and
a second transmitter in communication with the mapping engine and the client;
wherein the first transmitter transmits the encrypted identifier including the code associated with an article of commerce to the server and the second transmitter transmits the target Uniform Resource Locator to the client.

55. A system for logging requests for information from a server to a client, the system comprising:
a client comprising:
a code interpreter;
an identifier constructor in communication with the code interpreter, the identifier constructor constructing an identifier that specifies a source of the requested information, the identifier including a code associated with an article of commerce; and
a first transmitter in communication with the identifier constructor;
a server in communication with the client, the server comprising:
a mapping engine for mapping the identifier to a target Uniform Resource Locator;
a usage monitor in communication with the mapping engine for logging at least one portion of a server header response; and
a second transmitter in communication with the mapping engine and the client;
wherein the first transmitter transmits the identifier including the code associated with an article of commerce to the server and the second transmitter transmits the target Uniform Resource Locator to the client.

56. A system for providing information from a server to a client in response to a request from a user, the system comprising:
a client comprising:
a user request interface;
an identifier constructor in communication with the user request interface, the identifier constructor constructing an identifier that specifies a source of the requested information; and
a first transmitter in communication with the identifier constructor;
a server in communication with the client, the server comprising:
a locator for the server to locate the requested information in response to the identifier;
an error handling system in communication with the locator, the error handler system executing an error handling routine when the locator fails to locate the requested information in response to the identifier; and
a second transmitter in communication with the locator and the client;
wherein the first transmitter transmits the identifier to the server and the second transmitter transmits the requested information to the client when the server locates the requested information in response to the identifier, and transmits alternative content when the server fails to locate the requested information in response to the identifier.

57. A system for selecting a service level provided by a server to a client, the system comprising:
a client comprising:
a user request interface for receiving a request for information;
a selector in communication with the user request interface, the selector selecting a content type;
an identifier constructor in communication with the selector, the identifier constructor constructing an identifier that specifies a source of the requested information, the identifier including a designator specifying the content type; and
a transmitter in communication with the identifier constructor;
a server executing program instructions in response to the designator;
wherein the transmitter transmits the identifier with the included designator to the server.

58. A system to include supplementary data in a request for information from a server, the system comprising:
a client comprising:
an identifier constructor for constructing an identifier that specifies a source of the requested information;
a compression engine in communication with the identifier constructor, the compression engine compressing the supplementary data using a persistent compression, wherein the compressed supplementary data are included within the identifier; and
a transmitter for transmitting the identifier with the included compressed supplementary data to the server.
